(19) United States
(12) Patent Application Publication
(10) Pub. No.: US 2002/0038962 A1
(43) Pub. Date: Apr. 4, 2002

(54) Truck panel cover

(76) Inventor: Ernie Perez, La Mirida, CA (US)

Correspondence Address: Matthew J. Peirce, Esq., 1550 Starlight Canyon Avenue, Las Vegas, NV, 89123, US

(21) Appl. No.: 09/970,471

(22) Filed: Oct. 3, 2001

Related U.S. Application Data
(60) Provisional application No. 60/237,137, filed on Oct. 3, 2000.

(51) Int. Cl. B60J 7/20

(52) U.S. Cl. 296/136

(57) ABSTRACT

A new and improved covering apparatus is disclosed which would allow a user to cover the outer walls of the bed of a pickup truck. The present invention would comprise two main parts, which would include at least one permanent inner portion and at least one easily removable outer portion. The permanent inner portion would have two layers, which would include a rubber layer and a plastic layer, with the rubber layer being placed against the top of a truck bed panel toward the inside of the truck bed panel. Thus, the plastic layer would face the outside. The outer portion would also have two layers, a rubber layer and a plastic layer, with the rubber layer being placed against the top of a truck bed panel toward the outside of the truck bed panel. The edge of the outer portion that would be placed against the top of the truck bed panel would be placed over the edge of the permanent inner portion already in place. Each permanent inner portion and each outer portion would be fastened with fastening means, which would be snaps, magnets, straps, or other commonly used methods of fastening items to a flat metal surface.

### BACKGROUND OF THE INVENTION

The present invention is that of a new and improved covering apparatus which would allow a user to cover the outer walls of the bed of a pickup truck.

### DESCRIPTION OF THE PRIOR ART

U.S. Pat. No. 5,636,883, issued to Johns, discloses a pair of covers for the side walls of a pickup truck which consist of an outer panel cover and an inner panel cover removably attached along an edge.

U.S. Pat. No. 5,209,545, issued to Slaugh, discloses a covering which comprises separate cover sets of tough and strong flexible material, each set being made up of separate pieces for attachment to a longitudinal side of an automotive vehicle, normally a pickup truck, in serial arrangement to extend from the bottom to top of panels thereto.

U.S. Pat. No. 4,589,459, issued to Lantrip, discloses protective covers for use on vehicles.

### SUMMARY OF THE INVENTION

The present invention is that of a new and improved covering apparatus which would allow a user to cover the outer walls of the bed of a pickup truck. The present invention would comprise two main parts, which would include at least one permanent inner portion and at least one easily removable outer portion. The permanent inner portion would have two layers, which would include a rubber layer and a plastic layer, with the rubber layer being placed against the top of a truck bed panel toward the inside of the truck bed panel. Thus, the plastic layer would face the outside. The outer portion would also have two layers, a rubber layer and a plastic layer, with the rubber layer being placed against the top of a truck bed panel toward the outside of the truck bed panel. The edge of the outer portion that would be placed against the top of the truck bed panel would be placed over the edge of the permanent inner portion already in place. Each permanent inner portion and each outer portion would be fastened with fastening means, which would be snaps, magnets, straps, or other commonly used methods of fastening items to a flat metal surface.

There has thus been outlined, rather broadly, the more important features of a computer system for taxi drivers or other hired drivers in order that the detailed description thereof that follows may be better understood and in order that the present contribution to the art may be better appreciated. There are, of course, additional features of the computer system for taxi drivers or other hired drivers that will be described hereinafter and which will form the subject matter of the claims appended hereto.

In this respect, before explaining at least one embodiment of the computer system for taxi drivers or other hired drivers in detail, it is to be understood that the computer system for taxi drivers or other hired drivers is not limited in its application to the details of construction and to the arrangements of the components set forth in the following description or illustrated in the drawings. The computer system for taxi drivers or other hired drivers is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present computer system for taxi drivers or other hired drivers. It is important, therefore, that the claims be regard as including such equivalent constructions insofar as they do not depart from the spirit and scope of the present invention.

It is therefore an object of the present invention to provide a computer system for taxi drivers or other hired drivers which has all of the advantages of the prior art and none of the disadvantages.

It is another object of the present invention to provide a computer system for taxi drivers or other hired drivers which may be easily and efficiently manufactured and marketed.

It is another object of the present invention to provide a computer system for taxi drivers or other hired drivers which is of durable and reliable construction.

It is yet another object of the present invention to provide a computer system for taxi drivers or other hired drivers which is economically affordable and available to the buying public.

It is yet another object of the present invention to provide a computer system for taxi drivers or other hired drivers which provides additional benefits not present in the prior art.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a side view of a permanent inner portion and an outer portion of the present invention.

FIG. 2 shows a perspective view of the present invention in use.

FIG. 3 shows a side view of the present invention in use.

### DESCRIPTION OF THE PREFERRED EMBODIMENT

FIG. 1 shows a side view of a permanent inner portion 2 and an outer portion 4 of the present invention. The present invention is that of a new and improved covering apparatus which would allow a user to cover the outer walls of the bed of a pickup truck. The present invention would comprise a plurality of two main parts, which would include at least one permanent inner portion 2 and at least one outer portion 4. Each permanent inner portion 2 would have two layers, which would include a rubber layer 6 and a plastic layer 8, with the rubber layer 6 being placed against the top of a truck bed side panel 10 toward the inside of the truck bed side panel 10. Thus, the plastic layer 8 would face the outside.

The outer portion 4 would also have two layers, a rubber layer 12 and a plastic layer 14, with the rubber layer 12 being placed against the top of a truck bed side panel 10 toward the outside of the truck bed side panel 10. The edge of the outer portion 4 that would be placed against the top of the truck bed side panel 10 would be placed over the edge of the permanent inner portion 2 already in place.

Each permanent inner portion 2 and each outer portion 4 would be fastened with fastening means 16, which would be snaps, magnets, straps, or other commonly used methods of fastening items to a flat metal surface. FIG. 1 utilizes a snap 18 to fasten the permanent inner portion 2 to the truck bed side panel 10, while utilizing a screw 20 to fasten the outer portion 4 to the permanent inner portion 2. Of course, the representation of these specific fastening means is not meant to be limiting on the use of other, alternative types or combinations of fastening means when attaching a permanent inner portion 2 and outer portion 4 to a truck bed side panel 10.

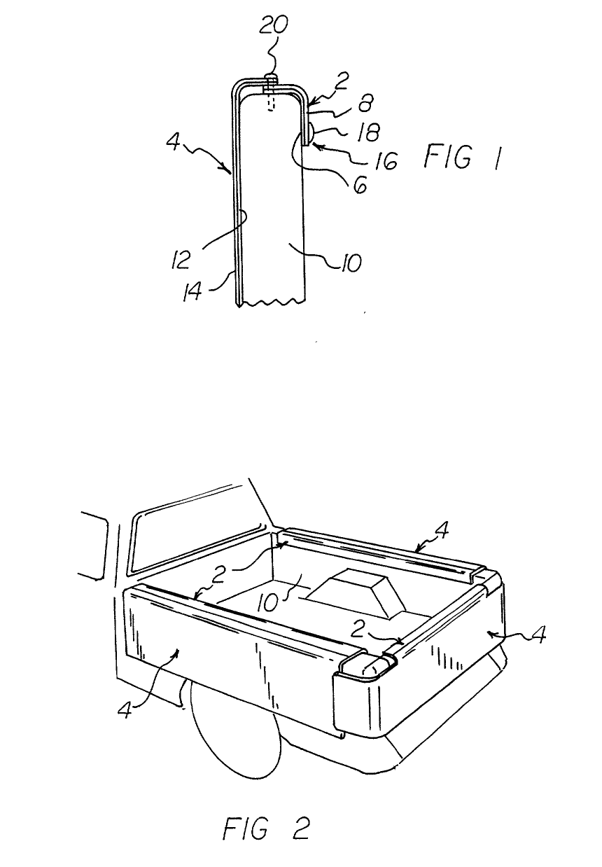

FIG. 2 shows a perspective view of the present invention in use. This picture is a representation if three outer portions 4 would be used in conjunction with three permanent inner portions 2.

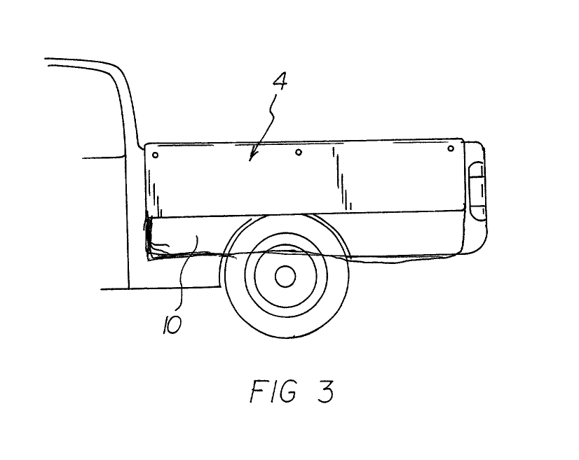

FIG. 3 shows a side view of the present invention in use. Outer portion 4 can be seen attached to a truck bed side panel 10.

What I claim as my invention is:

1. A covering apparatus for protecting an outer wall of a pickup truck bed in combination with a pickup truck bed wall, the wall being either a side wall or a rear wall, the wall having two surfaces, an outer surface and an inner surface, the wall also having a top surface, the covering apparatus comprising:
(a) an inner portion having two layers, an inner layer and an outer layer, the inner layer fabricated from rubber, the outer layer fabricated from plastic, the inner portion having two ends, a first end and a second end, the inner portion having two edges, an upper edge and a lower edge, the inner portion having a ninety degree bend approximately halfway between the first end and the second end, the upper edge being fixedly attached to the top of a pickup truck bed wall with the inner layer of the inner portion in contact with the top of the pickup truck bed wall, and the lower edge being fixedly attached to the inner surface of a pickup truck bed wall with the inner layer of the inner portion in contact with the inner surface of the pickup truck bed wall,
(b) an outer portion having two layers, an inner layer and an outer layer, the inner layer fabricated from rubber, the outer layer fabricated from plastic, the outer portion having two ends, a first end and a second end, the outer portion having two edges, an upper edge and a lower edge, the outer portion having a ninety degree bend quite close in proximity to the first end, the upper edge being fixedly attached to the upper edge of the inner portion with the inner layer of the outer portion in contact with the outer layer of the outer portion, and the lower edge covering the outer surface of a pickup truck bed wall with the inner layer of the outer portion in contact with the outer surface of the pickup truck bed wall.

2. A covering apparatus for protecting an outer wall of a pickup truck bed according to claim 1 wherein the upper edge of the inner portion is fixedly attached to the top of a pickup truck bed wall by a snap.

3. A covering apparatus for protecting an outer wall of a pickup truck bed according to claim 1 wherein the lower edge of the inner portion is fixedly attached to the inner surface of a pickup truck bed wall by a snap.

4. A covering apparatus for protecting an outer wall of a pickup truck bed according to claim 1 wherein the upper edge of the outer surface is fixedly attached to the upper edge of the inner portion by a snap.

5. A covering apparatus for protecting an outer wall of a pickup truck bed according to claim 1 wherein the upper edge of the inner portion is fixedly attached to the top of a pickup truck bed wall by a magnet.

6. A covering apparatus for protecting an outer wall of a pickup truck bed according to claim 1 wherein the lower edge of the inner portion is fixedly attached to the inner surface of a pickup truck bed wall by a magnet.

7. A covering apparatus for protecting an outer wall of a pickup truck bed according to claim 1 wherein the upper edge of the outer surface is fixedly attached to the upper edge of the inner portion by a magnet.

8. A covering apparatus for protecting an outer wall of a pickup truck bed according to claim 1 wherein the upper edge of the inner portion is fixedly attached to the top of a pickup truck bed wall by a strap.

9. A covering apparatus for protecting an outer wall of a pickup truck bed according to claim 1 wherein the lower edge of the inner portion is fixedly attached to the inner surface of a pickup truck bed wall by a strap.

10. A covering apparatus for protecting an outer wall of a pickup truck bed according to claim 1 wherein the upper edge of the outer surface is fixedly attached to the upper edge of the inner portion by a strap.
